(19) United States
(12) Patent Application Publication
(10) Pub. No.: US 2017/0364967 A1
(43) Pub. Date: Dec. 21, 2017

(54) PRODUCT FEEDBACK EVALUATION AND SORTING

(71) Applicant: eBay Inc., San Jose, CA (US)

(72) Inventors: Nish Parikh, Fremont, CA (US); Qifeng Qiao, Milpitas, CA (US); Syeda Hudda, San Ramon, CA (US); Naveen Kumar, Campbell, CA (US); Krithivasan Nagarajan, San Jose, CA (US); David Goldberg, Palo Alto, CA (US)

(21) Appl. No.: 15/282,571

(22) Filed: Sep. 30, 2016

Related U.S. Application Data
(60) Provisional application No. 62/352,551, filed on Jun. 20, 2016.

(51) Int. Cl. G06Q 30/02; G06N 99/00

(52) U.S. Cl. CPC G06Q 30/0282; G06N 99/005

(57) ABSTRACT

In various example embodiments, a system and method for evaluating and sorting product feedback is presented. In one example, a system includes a learning module to train a machine learning system on feedback from a plurality of users, the machine learning system configured to generate a quality rating for individual feedback, a feedback module to collect feedback for a specific product available from the online network based marketplace and apply the machine learning system to generate a quality rating for each feedback collected, and a sorting module to sort the feedback collected according to the quality ratings generated by the machine learning system.

### CROSS-REFERENCE TO RELATED APPLICATIONS

This application claims the benefit of priority to U.S. Provisional Pat. App. No. 62/352,551, titled “PRODUCT FEEDBACK EVALUATION AND SORTING” and filed Jun. 20, 2016, the disclosure of which is hereby incorporated by reference in its entirety.

### TECHNICAL FIELD

Embodiments of the present disclosure relate generally to evaluation of product feedback, and more particularly, but not by way of limitation, to machine based evaluation and sorting of product feedback and/or reviews.

### BACKGROUND

Conventionally, systems are configured to receive feedback regarding products and/or services received by consumers or users of the system. In some examples, the feedback includes single words, poorly structured language, inaccurate facts, or irrelevant comments. In other examples, feedback includes an accurate analysis, mature language, or helpful perspective.

In some examples, a system receives thousands of feedback comments and sorts them according to time. In another example, the feedback comments are sorted according to an accumulation of likes from other users. Distinguishing useless or irrelevant feedback from helpful insight or valuable comments is challenging.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a schematic block diagram illustration a feedback evaluation system according to one embodiment.

FIG. 3 is a flow chart diagram illustrating one embodiment of a method for product feedback evaluation and sorting.

FIG. 4 is another flow chart diagram illustrating one embodiment of a method for product feedback evaluation and sorting.

FIG. 5 is a diagram illustrating one example embodiment of coordinated operations between a feedback evaluation system and a machine learning system.

FIG. 6 is a block diagram illustrating an example of a software architecture that may be installed on a machine, according to some example embodiments.

FIG. 7 illustrates a diagrammatic representation of a machine in the form of a computer system within which a set of instructions may be executed for causing the machine to perform any one or more of the methodologies discussed herein, according to an example embodiment.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, a system as described herein, collects user interaction data that indicate how previous users have interacted with available products. As users view different types of feedback and either purchase or leave the system in a period of time or in a contiguous user session, the data is stored in a database of user interactions.

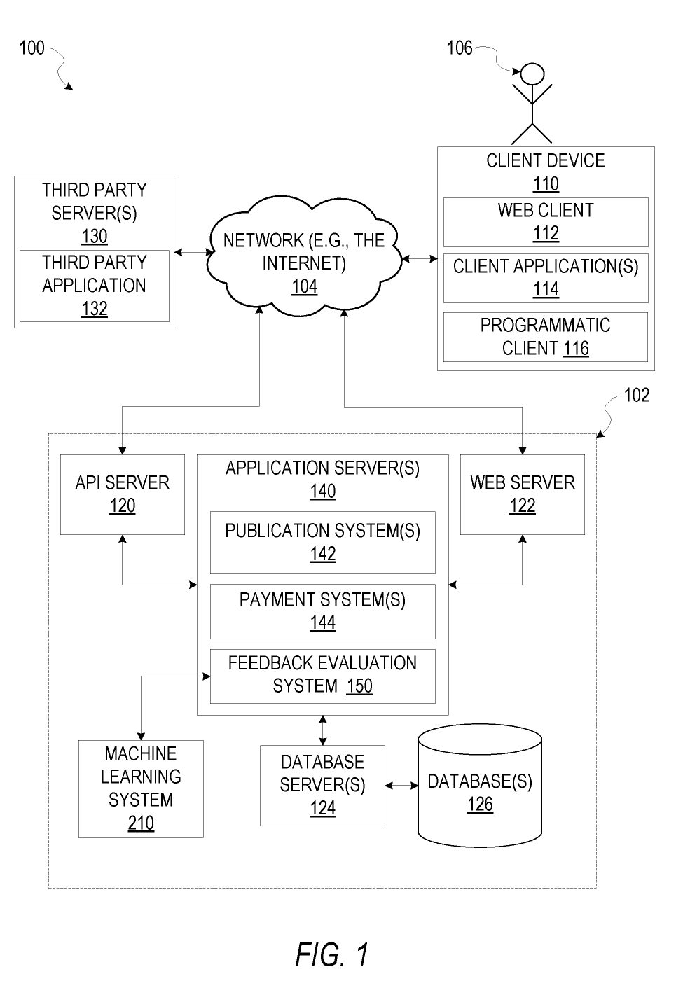

Over time, as thousands, or millions of user interactions are recorded, a system trains a machine learning system (FIG. 1 210) on the user interaction data to learn how certain feedback comments influence user behavior. In some example embodiments, certain types of feedback comments increase sales of a product. In other examples, feedback comments of a certain length increase a user's likelihood of leaving the system. In another example embodiment, feedback written at or above a certain grade level are given higher marks by readers of the feedback. In still other example embodiments, use of terms included in a description for the product increases a user's likelihood of purchasing the product. In one example embodiment, feedback variance from an average feedback rating has a greater influence on user behavior.

In certain example embodiments, the machine learning system 210 is configured to optimize a specific optimization function. As the system trains a machine learning system 210 based on user interactions and using the optimization function, the machine learning system 210 is configured to generate a quality rating for the indicated optimization function. In other example embodiments, the machine learning system 210 is configured to generate separate quality ratings for separate optimization functions.

In some example embodiments, the system then collects feedback comments for a specific product available at a network-based marketplace. In one example, the system retrieves the feedback comments from a database that stores the comments. In another example embodiment, the system applies the trained machine learning system 210 to the feedback comments for the specific product resulting in a quality rating for each of the feedback comments. The system may then sort the feedback comments according to the quality ratings and an associated optimization function.

In certain example embodiments, the system better evaluates feedback comments and learns to determine a quality rating for feedback comments. Accordingly, the system generates a quality rating for a product although there are relatively few comments. In one example, the system trains a machine learning system 210 on millions of feedback comments, but then applies the machine learning system 210 to comments for a product that includes less than five comments.

With reference to FIG. 1, an example embodiment of a high-level client-server-based network architecture 100 is shown. A networked system 102, in the example forms of a network-based marketplace or payment system, provides server-side functionality via a network 104 (e.g., the Internet or wide area network (WAN)) to one or more client devices 110. FIG. 1 illustrates, for example, a web client 112 (e.g., a browser, such as the Internet Explorer® browser developed by Microsoft® Corporation of Redmond, Washington State), an application 114, and a programmatic client 116 executing on client device 110.

The client device 110 may comprise, but are not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may utilize to access the networked system 102. In some embodiments, the client device 110 may comprise a display module (not shown) to display information (e.g., in the form of user interfaces). In further embodiments, the client device 110 may comprise one or more of a touch screens, accelerometers, gyroscopes, cameras, microphones, global positioning system (GPS) devices, and so forth. The client device 110 may be a device of a user that is used to interact with networked system 102. In one embodiment, the networked system 102 is a network-based marketplace that responds to requests for product listings, publishes publications comprising item listings of products available on the network-based marketplace, and manages payments for these marketplace transactions. In another example embodiment, the networked system 102 received feedback comments from users of the networked system 102. One or more users 106 may be a person, a machine, or other means of interacting with client device 110. In embodiments, the user 106 is not part of the network architecture 100, but may interact with the network architecture 100 via client device 110 or another means. For example, one or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each of the client device 110 may include one or more applications (also referred to as “apps”) such as, but not limited to, a web browser, messaging application, electronic mail (email) application, an e-commerce site application (also referred to as a marketplace application), and the like. In some embodiments, if the e-commerce site application is included in a given one of the client device 110, then this application is configured to locally provide the user interface and at least some of the functionalities with the application configured to communicate with the networked system 102, on an as needed basis, for data and/or processing capabilities not locally available (e.g., access to a database of items available for sale, to authenticate a user, to verify a method of payment, etc.). Conversely if the e-commerce site application is not included in the client device 110, the client device 110 may use its web browser to access the e-commerce site (or a variant thereof) hosted on the networked system 102. In one specific examples, the client device 110 includes a web browser that receives a user interface allowing the user to provide one or more feedback comments for a product available via the networked system 102.

One or more users 106 may be a person, a machine, or other means of interacting with the client device 110. In example embodiments, the user 106 is not part of the network architecture 100, but may interact with the network architecture 100 via the client device 110 or other means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

An application program interface (API) server 120 and a web server 122 are coupled to, and provide programmatic and web interfaces respectively to, one or more application servers 140. The application servers 140 may host one or more publication systems 142, payment systems 144, and/or the feedback evaluation system 150, each of which may comprise one or more modules or applications and each of which may be embodied as hardware, software, firmware, or any combination thereof. The application servers 140 are, in turn, shown to be coupled to one or more database servers 124 that facilitate access to one or more information storage repositories or database(s) 126. In an example embodiment, the databases 126 are storage devices that store information to be posted (e.g., publications or listings) to the publication system 120. The databases 126 may also store digital item information in accordance with example embodiments. In one example embodiment, one database server 124 stored feedback comments from users of the networked system 102. The database 124 may also store user interactions with the networked system 102.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party. The third party website, for example, provides one or more promotional, marketplace, or payment functions that are supported by the relevant applications of the networked system 102.

The publication systems 142 may provide a number of publication functions and services to users 106 that access the networked system 102. The payment systems 144 may likewise provide a number of functions to perform or facilitate payments and transactions. While the publication system 142 and payment system 144 are shown in FIG. 1 to both form part of the networked system 102, it will be appreciated that, in alternative embodiments, each system 142 and 144 may form part of a payment service that is separate and distinct from the networked system 102. In some embodiments, the payment systems 144 may form part of the publication system 142.

The personalization system 150 may provide functionality operable to perform various personalizations using the user selected data. For example, the personalization system 150 may access the user selected data from the databases 126, the third party servers 130, the publication system 120, and other sources. In some example embodiments, the personalization system 150 may analyze the user data to perform personalization of user preferences. As more content is added to a category by the user, the personalization system 150 can further refine the personalization. In some example embodiments, the personalization system 150 may communicate with the publication systems 120 (e.g., accessing item listings) and payment system 122. In an alternative embodiment, the personalization system 150 may be a part of the publication system 120.

Further, while the client-server-based network architecture 100 shown in FIG. 1 employs a client-server architecture, the present inventive subject matter is of course not limited to such an architecture, and could equally well find application in a distributed, or peer-to-peer, architecture system, for example. The various publication system 142, payment system 144, and personalization system 150 could also be implemented as standalone software programs, which do not necessarily have networking capabilities.

The web client 112 may access the various systems 142, 144, and 150 via the web interface supported by the web server 122. Similarly, the programmatic client 116 accesses the various services and functions provided by the publication and payment systems 142 and 144 via the programmatic interface provided by the API server 120. The programmatic client 116 may, for example, be a seller application (e.g., the Turbo Lister application developed by eBay® Inc., of San Jose, Calif.) to enable sellers to author and manage listings on the networked system 102 in an off-line manner, and to perform batch-mode communications between the programmatic client 116 and the networked system 102.

Additionally, a third party application(s) 128, executing on a third party server(s) 130, is shown as having programmatic access to the networked system 102 via the programmatic interface provided by the API server 114. For example, the third party application 128, utilizing information retrieved from the networked system 102, may support one or more features or functions on a website hosted by the third party. The third party website may, for example, provide one or more promotional, marketplace, or payment functions that are supported by the relevant applications of the networked system 102.

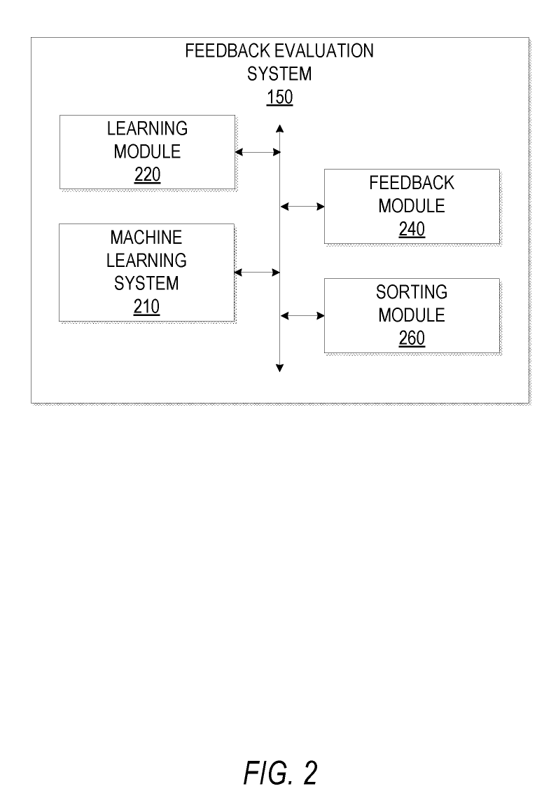

FIG. 2 is a schematic block diagram illustration 200 a feedback evaluation system 150 according to one embodiment. In one example embodiment, the feedback evaluation system 150 includes a learning module 220, a feedback module 240, a machine learning system 210, and a sorting module 260.

In one example embodiment, the learning module 220 is configured to train a machine learning system 210 on feedback from a plurality of users and user interaction data from those users. As a result of the machine learning system 210 training on user feedback comments and user interaction data, the machine learning system 210 learns to generate a quality rating for feedback comments.

In another example embodiment, the feedback evaluation system 150 is configured to log user interaction data with the networked system 102. As users view feedback comments and perform other actions with the networked system 102, the machine learning system 210 learns how certain feedback comments influence user interactions.

In some example embodiments, the learning module 220 logs user interactions over a period of time. In one example, the period of time is one day. In another example embodiment, the learning module 220 logs user interactions in a user session. In another example embodiment, the learning module 220 logs user interactions on a “mission” basis. In one example, a mission includes a time when a user begins looking for a product, and when the user purchases the product.

In one example embodiment, the learning module 220 trains the machine learning system 210 on any and all aspects, features, or properties of a feedback comment. In one example embodiment, the learning module 220 trains the machine learning system 210 using a length of feedback comments. In one hypothetical example, as users tend to leave a product page in response to a feedback comment that is shorter than 20 characters, the machine learning system 210 learns that feedback comments that are less than 20 characters in length tends to decrease user likelihood of purchasing a product.

In one hypothetical example embodiment, the machine learning system 210 may learn that feedback comments that are limited to comments such as, but not limited to, “I liked it,” “awesome,” “thanks,” or the like, do not increase a user's likelihood of purchasing the product. In response, the machine learning system 210 assigns a lower quality metric to the feedback comment because it does not appear (e.g., based on a statistical likelihood according to previous data used to train the machine learning system 210) to influence user interactions with web pages that display the product.

In another example embodiment, the learning module 220 gauges a reading level for the feedback comments. As one skilled in the art may appreciate, a reading level may be determined for a segment of text based, at least in part, on terms used, grammar, average sentence length, or the like. In this example embodiment, the learning module 220 determines a reading level for the feedback comments. In a hypothetical example, as a higher percentage of users that view feedback above a certain reading level tend to purchase the product, the machine learning system 210 learns that such comments increase likelihood that users will purchase the product.

In one hypothetical example embodiment, the machine learning system 210 may learn that a feedback comment written at a reading level above the 8^{th} grade (as one skilled in the art may appreciate), the feedback comment influences user interactions, while a feedback comment written above the 12^{th} grade reading level decreases user interactions. In such examples, the machine learning system 210 may assign a higher quality rating for a feedback comment written at a 10^{th} grade level and may decrease a quality rating for a feedback comment written at a 14^{th} grade reading level. Of course, the machine learning system 210 may discover other correlations.

In one example embodiment, the learning module 220 determine whether or not the feedback comment uses correct grammar. As one skilled in the art may appreciate, the feedback comment may be analyzed for correct grammar. In one example, the learning module 220 uses natural language processing to analyze grammar. In a hypothetical example, in response to users who view a feedback comment that uses incorrect grammar and subsequently do not purchase the product, the machine learning system 210 learns that feedback posts that include incorrect grammar decrease likelihood that users will purchase associated products.

In another example embodiment, the learning module 220 trains the machine learning system 210 to learn how feedback comments engage the user. In one example, the machine learning system 210 may that particular feedback comments that include terms used by the description or title for the product increase user interactions with the product. In response, the machine learning system 210 learns that feedback comments including such terms increase user interactions. Correspondingly, the machine learning system 210 increases a quality rating for such feedback comments because they increase user interactions.

In one example embodiment, the learning module 220 modifies a quality score for a feedback in response to the feedback including specific predefined terms. In one example, the predefined terms include profanity according to the language of the feedback and in response, decreases a quality score for the feedback. In another example embodiment, the learning module 220 increases the quality score for the feedback in response to the feedback including, “seller,” “shipping,” or other terms that imply relevant feedback.

In one example embodiment, the learning module 220 trains the machine learning system 210 to learn how feedback completeness affects user interactions. In one hypothetical example embodiment, the machine learning system 210 may learn that incomplete feedback comments do not increase user engagement. In one example, a feedback form includes 5 different selections and a user providing feedback may only complete 4 of the selections. In response to such an incomplete feedback, the machine learning system 210 may assign a lower quality rating to the feedback because it does not affect or decreases user interactions.

In another example embodiment, the learning module 220 trains the machine learning system 210 to learn how feedback accuracy affects user interactions. In one example embodiment, the machine learning system 210 may learn that inaccurate feedback comments decrease user interactions and/or decrease user likelihood of purchasing the product. In response, the machine learning system 210 assigns a lower quality rating to such feedback comments. In one example, the feedback comment is inaccurate because it described an incorrect size, incorrect color, incorrect purpose or application, or other incorrect feature of the product.

In one example embodiment, the learning module 220 trains the machine learning system 210 to learn differently for each product category. In this example, the machine learning system 210 separates product category and learns how different feedback comments in different categories affect user interactions and/or user likelihood of purchasing a product. In one example, feedback comments in an electronics category affect users different than similar feedback comments in an artistic category.

In another example embodiment, the learning module 220 trains using product age or feedback age. In one example embodiment, the learning module 220 trains using feedback variance from other feedback ratings. In one example, an average of feedbacks rate of a particular product as a four out of stars. In response to a particular feedback rating being one star out of five stars, the machine learning system 210 may increase or decrease a quality rating for the particular feedback comment based, at least in part, on how similar feedback comments (e.g., feedback comments with a similar variance) influence user interactions with the networked system 102.

In one example embodiment, the learning module 220 trains using feedback relevance. In one example, feedback relevance is measured using feedback terms that match terms in a set of predefined relevant terms. In one example, relevant terms for an automobile include style, color, speed, performance capabilities, braking, features, audio systems, etc. In response to a particular feedback comment not addressing any of the predefined relevant terms, the machine learning system 210 may learn that feedback ratings that do not include any of the relevant terms to not increase a user's interactions with the networked system 102 whereas feedback comments that address relevant terms are assigned a higher quality rating.

In another example embodiment, a rating of the user providing the feedback is included in the machine learning functions. Accordingly, as a particular user frequently generates highly rated feedback comments, the machine learning system 210 may increase a quality rating for feedback comments received from the user. In another example embodiment, as a particular user consistently generates lower rated feedback comments, the user's rating may decrease subsequent feedback comment rating based, at least in part, on the rating of the individual user. In another example embodiment, the machine learning system 210 also includes whether or not the user providing the feedback has purchased the item or not. In one example, the machine learning system 210 increases a quality rating for a feedback comment from a user that has purchased the product being rated. In other embodiments, the learning module 220 trains on whether the user is a verified buyer, a non-verified buyer, or an unknown buyer.

In one example embodiment, the learning module 220 trains using a threshold percentage of reviews from a specific user above a certain quality threshold. In one example, in response to 50% or more feedback comments being rated above a certain quality value, the learning module 220 learns that this particular user generally provides helpful feedback and increases a score for feedback from this particular user. The learning module 220 may also train on a total number of reviews the user has provided.

In another example embodiment, the learning module 220 trains using a rating divergence. A rating divergence, as described herein, at least includes a difference between an individual rating from a specific user and an average product rating. In one example, this rating divergence is represented as a percentage of difference over an average product rating.

In another example embodiment, the learning module 220 trains on similarity between a content in a feedback and product information (e.g., product title, product description, product feature, aspect, or the like). In one example, the feedback includes a brand or model of the product being described in the feedback. In certain example, a similarity includes a product attribute being included in the feedback. In another example, a similarity includes an average, median, maximum, or percentage occurrence of a product attribute in the feedback. In one example embodiment, the similarity includes a normalized occurrence frequency of product attributes over a word length of the feedback. In other embodiments, the similarity includes semantic relatedness of word senses, such as, but not limited to, path length similarity, dice coefficient similarity based on path length score, or the like.

Other features of feedback include, a number of sentences, a number of words, a number of punctuations, a number of nouns, a number of verbs, a number of adjectives, a total feedback length, a language of the feedback as compared with a language of the product being reviewed, or the like. In certain embodiments, the learning module 220 trains the machine learning system 210 on a reduced set of input feedback by using a random sub-sampling of the input feedback. In another example embodiment, the learning module 220 trains the machine learning system 210 using synthetic minority over-sampling as one skilled in the art will appreciate.

In one example embodiment, the learning module 220 trains on duplication measurements of the feedback. In certain examples, the duplication measurements include maximum duplication word frequency, maximum duplication word ratio to full review term length, minimum term duplication word frequency, and minimum duplication word ratio to full review term length.

In one example embodiment, the learning module 220 retrains the machine learning system 210 at regular intervals. In certain examples, the learning module 220 retrains the machine learning system 210 hourly, daily, weekly, monthly, yearly, or the like. Of course, other time periods may be used and this disclosure is not limited in this regard.

In another example embodiment, the feedback module 240 collects feedback for a specific product available from the networked marketplace and applies the machine learning system 210 to generate a quality rating for each feedback collected. In one example, the feedback module 240 retrieves the feedback comments from the database server 124. In another example embodiment, the feedback module 240 collects the feedbacks via a user interface provided by an application server 140.

In one example embodiment, the sorting module 260 is configured to sort the feedbacks according to the quality ratings generated by the machine learning system 210.

In certain example embodiments, the machine learning system 210 optimizes quality ratings to optimize for feedback that is most helpful to potential buyers. In one example, feedbacks that tend to increase user interactions may be deemed more helpful to users. In another example embodiment, the optimization function is sales. For example, the machine learning system 210 may be configured to learn how individual feedback comments affect sales of a product and generate corresponding quality ratings for the optimization function. In certain examples, the optimization functions include feedback relevance and feedback that yield most positive votes. As one skilled in the art may appreciate, other optimization functions may be used and this disclosure is not limited in this regard. In other examples, an administrator of the feedback evaluation system 150 may provide other optimization functions and the learning module 220 trains the machine learning system 210 according to the received optimization function. In yet another example, the feedback evaluation system 150 indicates available optimization functions to a user of the networked system 150 and optimizes according to user preference.

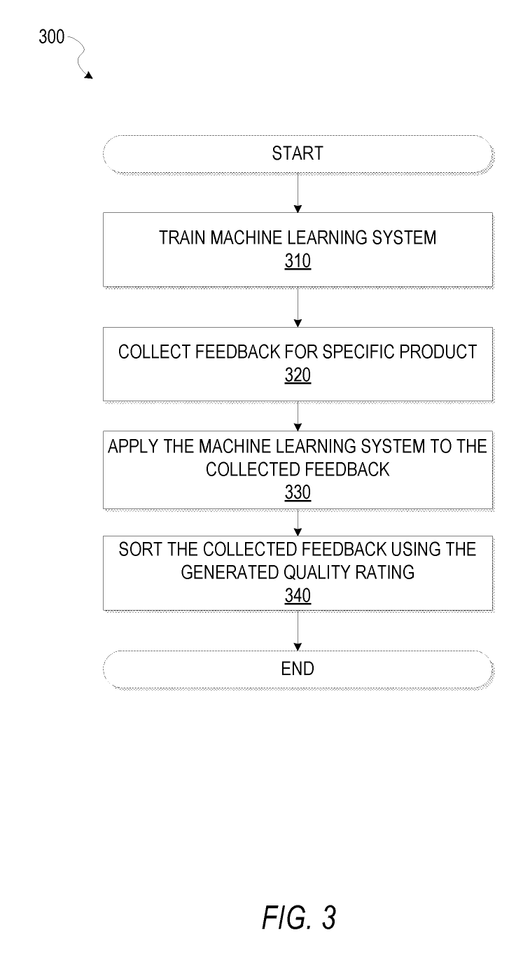

FIG. 3 is a flow chart diagram illustrating one embodiment of a method for product feedback evaluation and sorting. Operations in the method may be performed by modules described in FIG. 2 and are described by reference thereto.

In one example, the method 300 begins and at operation 310 the learning module 220 trains a machine learning system 210 using user interaction data and feedback comments provided by users. The method 300 continues at operation 320 and the feedback module 240 collects feedback for a particular product. In one example, the feedback module 240 retrieves feedback from a database.

The method 300 continues at operation 330 and the feedback module 240 applies the machine learning system 210 to the collected feedback resulting in a quality metric for each collected feedback. The method 300 continues at operation 340 and the sorting module 260 sorts, at a user interface for the networked system 102, the collected feedbacks according to the assigned quality rating. In this way, feedback comments that are most likely to affect a user's purchase are viewed by the user prior to other feedback comments based, at least in part, on the optimization function used to generate the quality rating. Furthermore, feedback comments that are less helpful, influential, relevant, correct, or otherwise helpful receive a lower quality rating and are optionally viewed after viewing the more relevant feedback comments.

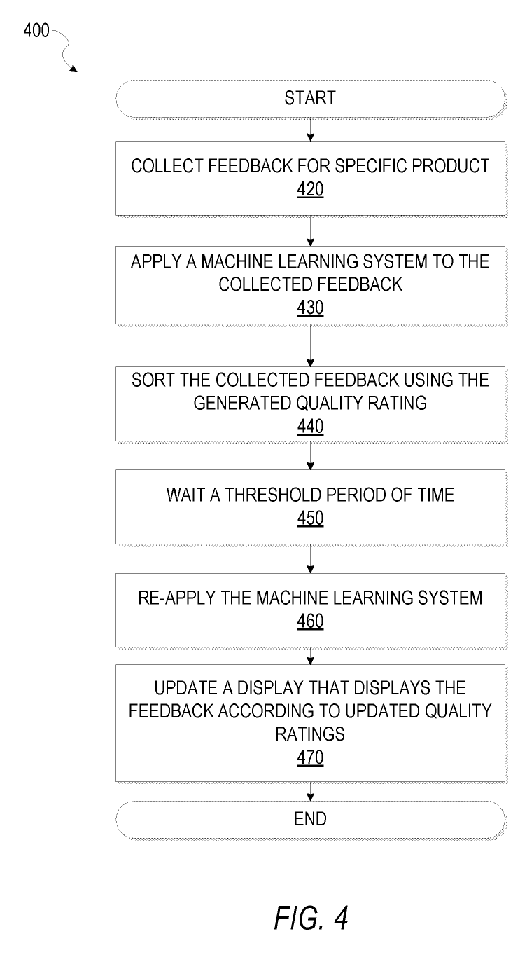

FIG. 4 is another flow chart diagram illustrating one embodiment of a method 400 for product feedback evaluation and sorting. Operations in the method 400 may be performed by modules described in FIG. 2 and are described by reference thereto.

In one example, the method 400 begins and at operation 420 the feedback module 240 collects feedback for a specific product. In one example, the feedback module 240 retrieves feedback from a remote feedback system.

The method 400 continues at operation 430 and the feedback module 240 applies the machine learning system 210 to the collected feedback resulting in a quality metric for each collected feedback. The method 400 continues at operation 440 and the sorting module 260 sorts the collected feedbacks according to the assigned quality rating.

The method 400 continues at operation 450 and the feedback module 240 waits a threshold period of time. In one example, the threshold period of time is seven days.

The method 400 continues at operation 460 and feedback module 240 re-applies the machine learning system 210 to the collected feedback resulting in a quality metric for each collected feedback. In one example, the machine learning system 210 includes user ratings the provided the feedback. In this way, a user's provide feedback for other products and their respective ratings either increase or decrease, the machine learning system 210 accounts for their respective quality ratings and updates the quality ratings for feedbacks provided by the users using their updated user quality ratings.

The method 400 continues at operation 400 and the sorting module 260 updates a display that displays the feedback comments according to the updated quality ratings.

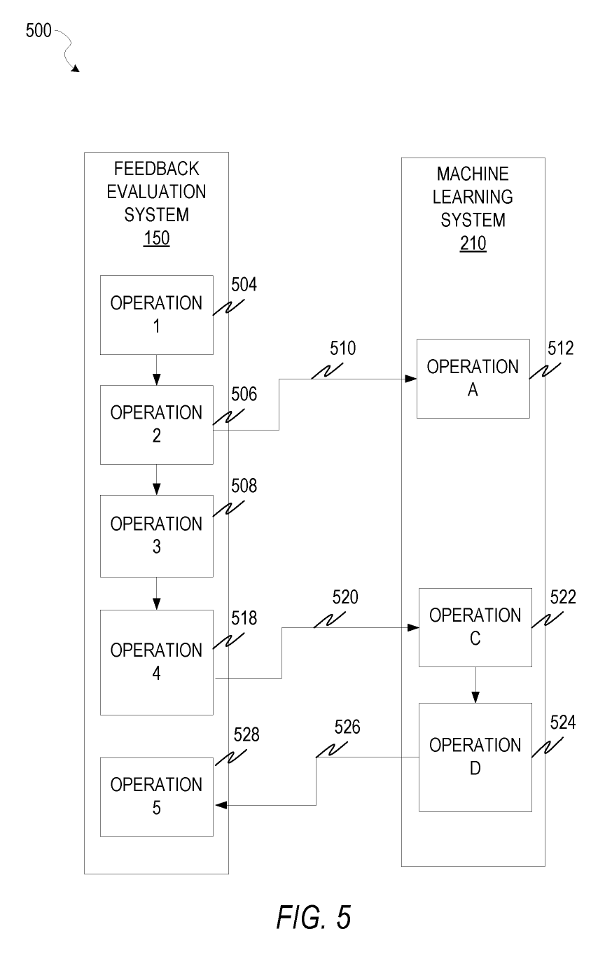

FIG. 5 is a diagram illustrating one example embodiment of coordinated operations between a feedback evaluation system and a machine learning system 210.

In one example embodiment, at operation 1 (504), the learning module 220 collects feedback comments for users of the networked system 102. At operation 2 (506), the learning module 220 transmits, using an electronic network interface, the collected feedback comments to the machine learning system 210. At operation A (512), the machine learning system 210 trains on the feedback comments.

At operation 3 (508), the learning module 220 collects feedback comments for a particular product available for purchase at the networked system 102. At operation 4 (518), the feedback module 240 transmits 520 the particular feedback comments to the machine learning system 210. At operation D (524) the machine learning system 210 generates quality ratings for each of the particular feedback comments and transmits 526 the quality ratings back to the feedback evaluation system 150.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-5 are implemented in some embodiments in the context of a machine and an associated software architecture. The sections below describe representative software architecture(s) and machine (e.g., hardware) architecture that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Software Architecture

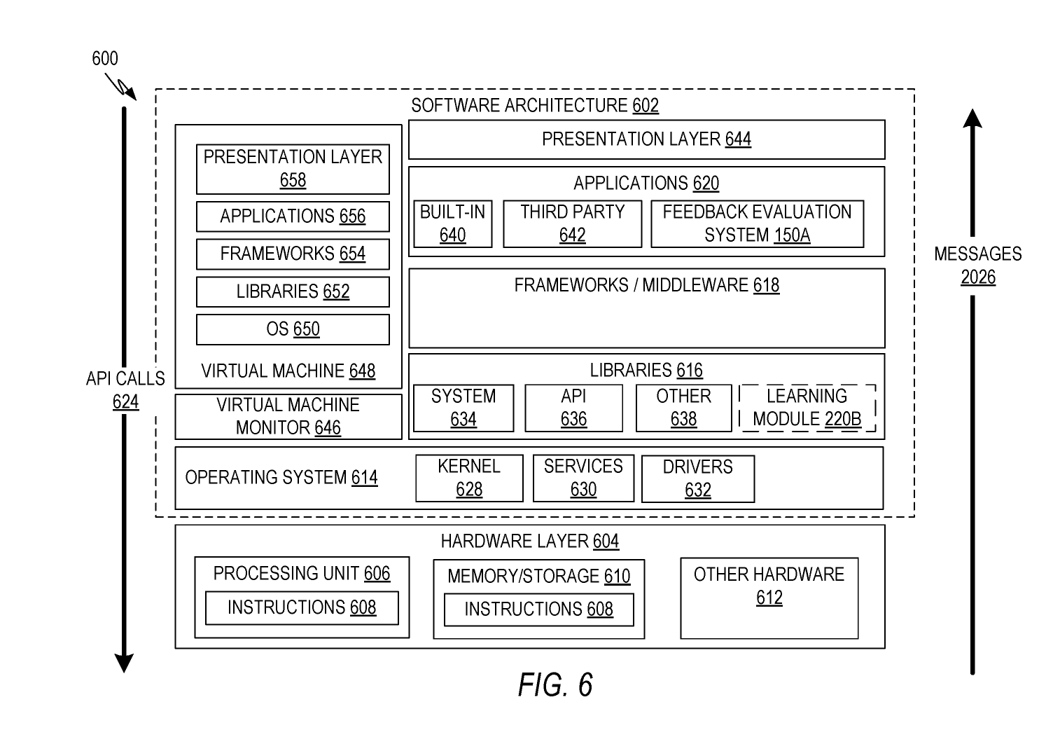

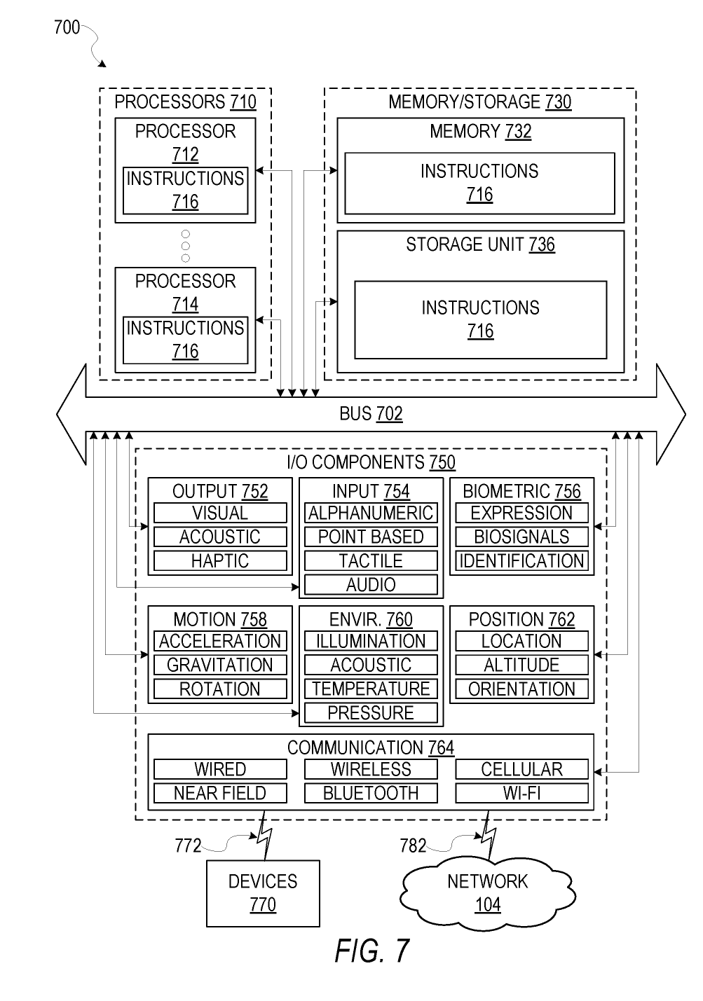

FIG. 6 is a block diagram 600 illustrating a representative software architecture 602, which may be used in conjunction with various hardware architectures herein described. FIG. 6 is merely a non-limiting example of a software architecture and it will be appreciated that many other architectures may be implemented to facilitate the functionality described herein. The software architecture 602 may be executing on hardware such as machine 700 of FIG. 7 that includes, among other things, processors 710, memory 730, and I/O components 750. A representative hardware layer 604 is illustrated and can represent, for example, the machine 700 of FIG. 7. The representative hardware layer 604 comprises one or more processing units 606 having associated executable instructions 608. Executable instructions 608 represent the executable instructions of the software architecture 602, including implementation of the methods, modules and so forth of FIGS. 1-5. Hardware layer 604 also includes memory and/or storage modules 610, which also have executable instructions 608. Hardware layer 604 may also comprise other hardware as indicated by 612 which represents any other hardware of the hardware layer 604, such as the other hardware illustrated as part of machine 700.

In the example architecture of FIG. 6, the software 602 may be conceptualized as a stack of layers where each layer provides particular functionality. For example, the software 602 may include layers such as an operating system 614, libraries 616, frameworks/middleware 618, applications 620 and presentation layer 622. Operationally, the applications 620 and/or other components within the layers may invoke application programming interface (API) calls 624 through the software stack and receive a response, returned values, and so forth illustrated as messages 626 in response to the API calls 624. The layers illustrated are representative in nature and not all software architectures have all layers. For example, some mobile or special purpose operating systems may not provide a frameworks/middleware layer 618, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than to interface directly with the underlying operating system 614 functionality (e.g., kernel 628, services 630 and/or drivers 632). The libraries 616 may include system 634 libraries (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks 618 (also sometimes referred to as middleware) may provide a higher-level common infrastructure that may be utilized by the applications 620 and/or other software components/modules. For example, the frameworks 618 may provide various graphic user interface (GUI) functions, high-level resource management, high-level location services, and so forth. The frameworks 618 may provide a broad spectrum of other APIs that may be utilized by the applications 620 and/or other software components/modules, some of which may be specific to a particular operating system or platform.

The applications 620 includes built-in applications 640 and/or third party applications 642. Examples of representative built-in applications 640 may include, but are not limited to, a contacts application, a browser application, a book reader application, a location application, a media application, a messaging application, and/or a game application. Third party applications 642 may include any of the built in applications as well as a broad assortment of other applications. In a specific example, the third party application 642 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 642 may invoke the API calls 624 provided by the mobile operating system such as operating system 614 to facilitate functionality described herein. In other example embodiments, the application 620 include the feedback evaluations system 150A. Therefore, the feedback evaluation system 150A may be programmed as an application. In other example embodiment, at least a portion of the feedback evaluation system 150 is programmed as a library 616. In one example, the learning module 220B is coded as a library and the other modules of the feedback evaluation system 150 communicate with the learning module 220B using an API 636, or other electronic interface.

The applications 620 may utilize built in operating system functions (e.g., kernel 628, services 630 and/or drivers 632), libraries (e.g., system 634, APIs 636, and other libraries 638), frameworks/middleware 618 to create user interfaces to interact with users of the system. Alternatively, or additionally, in some systems interactions with a user may occur through a presentation layer, such as presentation layer 644. In these systems, the application/module “logic” can be separated from the aspects of the application/module that interact with a user.

Some software architectures utilize virtual machines. In the example of FIG. 6, this is illustrated by virtual machine 648. A virtual machine creates a software environment where applications/modules can execute as if they were executing on a hardware machine (such as the machine of FIG. 7, for example). A virtual machine is hosted by a host operating system (operating system 614 in FIG. 7) and typically, although not always, has a virtual machine monitor 646, which manages the operation of the virtual machine as well as the interface with the host operating system (i.e., operating system 614). A software architecture executes within the virtual machine such as an operating system 650, libraries 652, frameworks/middleware 654, applications 656 and/or presentation layer 658. These layers of software architecture executing within the virtual machine 648 can be the same as corresponding layers previously described or may be different.

### Example Machine Architecture and Machine-Readable Medium

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example the instructions may cause the machine to execute the flow diagrams of FIGS. 3-5. Additionally, or alternatively, the instructions may implement the learning module 220, the feedback module 240, and the sorting module 260 of FIG. 2, and so forth. The instructions transform the general, non-programmed machine into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 712 and processor 714 that may execute instructions 716. The term “processor” is intended to include multi-core processor that may comprise two or more independent processors (sometimes referred to as “cores”) that may execute instructions contemporaneously. Although FIG. 7 shows multiple processors, the machine 700 may include a single processor with a single core, a single processor with multiple cores (e.g., a multi-core process), multiple processors with a single core, multiple processors with multiples cores, or any combination thereof.

The memory/storage 730 may include a memory 732, such as a main memory, or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of processors 710 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 716. The term “machine-readable medium” shall also be taken to include any hardware or physical medium, or combination of multiple media, that is capable of storing instructions (e.g., instructions 716) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via coupling 782 and coupling 772 respectively. For example, the communication components 764 may include a network interface component or other suitable device to interface with the network 780. In further examples, communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to devices 770. The term “transmission medium” shall be taken to include any intangible medium that is capable of storing, encoding, or carrying instructions 716 for execution by the machine 700, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A system comprising:
a machine-readable medium having instructions stored thereon, which, when executed by a processor, causes the system to perform operations comprising:
training a machine learning system on feedback from a plurality of users, the machine learning system configured to generate a quality rating for individual feedback using technical analysis of terms used in the feedback;
collecting feedback for a specific product available from the online network based marketplace and apply the machine learning system to generate a quality rating for each feedback collected;
sorting the feedback collected according to the quality ratings generated by the machine learning system.

2. The system of claim 1, wherein the machine learning system generates quality ratings for feedback using at least one of feedback length, feedback grammar, feedback accuracy, feedback reading level, feedback correlation with product description, product category, product age, feedback completeness, feedback user rating, time passage from feedback time, feedback variance from average feedback, and feedback relevance.

3. The system of claim 1, wherein the machine learning system decreases the quality rating for feedback that includes less than a threshold number of words.

4. The system of claim 1, wherein the machine learning system decreases the quality rating for feedback that includes incorrect grammar.

5. The system of claim 1, wherein the machine learning system decreases the quality rating for feedback that includes incorrect facts.

6. The system of claim 1, wherein the machine learning system decreases the quality rating for feedback that is incomplete.

7. The system of claim 1, wherein the operations further comprise updating a user rating for the user that provided the feedback based on the quality rating generated for the feedback.

8. The system of claim 1, wherein the operations further comprise, after a threshold period of time, re-applying the machine learning system to collected feedback.

9. The system of claim 1, wherein the machine learning system is configured to optimize according to two or more optimization functions, the machine learning system generating separate quality ratings based on each optimization function.

10. The system of claim 1, wherein the optimization functions are selected from the group consisting of:
feedback that is most helpful to potential buyers,
feedback that is most likely to increase sales of the product,
feedback that is most relevant to the product; and
feedback that will most likely yield positive votes.

11. A method comprising:
training a machine learning system on feedback from a plurality of users, the machine learning system configured to generate a quality rating for individual feedback;
collecting feedback for a specific product available from a networked marketplace and apply the machine learning system to generate a quality rating for each feedback collected; and
sorting the feedback collected according to the quality ratings generated by the machine learning system.

12. The method of claim 11, wherein the machine learning system generates quality ratings for feedback using at least one of feedback length, feedback grammar, feedback accuracy, feedback reading level, feedback correlation with product description, product category, product age, feedback completeness, feedback user rating, time passage from feedback time, feedback variance from average feedback, and feedback relevance.

13. The method of claim 11, wherein the machine learning system decreases the quality rating for feedback that includes less than a threshold number of words.

14. The method of claim 11, wherein the machine learning system decreases the quality rating for feedback that includes incorrect grammar.

15. The method of claim 11, wherein the machine learning system decreases the quality rating for feedback that includes incorrect facts.

16. The method of claim 11, wherein the machine learning system decreases the quality rating for feedback that is incomplete.

17. The method of claim 11, wherein the feedback module updates a user rating for the user that provided the feedback based on the quality rating generated for the feedback.

18. The method of claim 11, wherein the feedback module, after a threshold period of time, re-applies the machine learning system to collected feedback.

19. The method of claim 11, wherein the machine learning system is configured to optimize according to two or more optimization functions, the machine learning system generating separate quality ratings based on each optimization function.

20. A machine-readable hardware medium having instructions stored thereon, which, when executed by a processor, cause the processor to perform:
training a machine learning system on feedback from a plurality of users, the machine learning system configured to generate a quality rating for individual feedback;
collecting feedback for a specific product available from a networked marketplace and apply the machine learning system to generate a quality rating for each feedback collected; and
sorting the feedback collected according to the quality ratings generated by the machine learning system.
